(19) United States
(12) Patent Application Publication
(10) Pub. No.: US 2013/0212659 A1
(43) Pub. Date: Aug. 15, 2013

(54) TRUSTED CONNECTED VEHICLE SYSTEMS AND METHODS

(71) Applicant: Intertrust Technologies Corporation, (US)

(72) Inventors: David P. Maher, Livermore, CA (US); Jack Lacy, Warren, NJ (US); Gary Ellison, San Mateo, CA (US); Yutaka Nagao, Cupertino, CA (US)

(73) Assignee: INTERTRUST TECHNOLOGIES CORPORATION, Sunnyvale, CA (US)

(21) Appl. No.: 13/766,432

(22) Filed: Feb. 13, 2013

Related U.S. Application Data
(60) Provisional application No. 61/598,218, filed on Feb. 13, 2012.

(51) Int. Cl. H04L 29/06

(52) U.S. Cl. CPC H04L 63/00
USPC 726/6

(57) ABSTRACT

This disclosure relates to systems and methods for facilitating a security and trust architecture in connected vehicles. In certain embodiments, a method for creating a trusted architecture in a connected vehicle may include generating a connected vehicle ecosystem map including information relating to a plurality of electronic control units and network connections included in the connected vehicle. Based on the vehicle ecosystem map, trusted relationships involving electronic control units may be identified. Trusted credentials may be generated and issued to electronic control units that meet one or more trust requirements. Using the trusted credentials, trusted communication within the connected vehicle may be achieved.

### RELATED APPLICATIONS

This application claims the benefit of priority under 35 U.S.C. §119(e) to U.S. Provisional Patent Application No. 61/598,218, filed Feb. 13, 2012, and entitled “TRUSTED NETWORKED VEHICLE SYSTEMS AND METHODS,” which is hereby incorporated by reference in its entirety.

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### BACKGROUND AND SUMMARY

The present disclosure relates generally to systems and methods for facilitating a security and trust architecture in connected vehicles. More specifically, the present disclosure relates to systems and methods for protecting connected vehicles and/or the systems and/or data associated therewith from unauthorized, unwanted, and/or unintended access, use and/or tampering using security, trust, and privacy management techniques.

Vehicles include many components, systems, and devices configured to communicate through a variety of communication channels that are internal and external to the vehicle. For example, a vehicle may include a variety of sensors configured to provide operating information to one or more computing systems in the vehicle via wired or wireless communication pathways. Similarly, many vehicles now include telematics systems that can provide information relating to a location of the vehicle, in-vehicle infotainment systems that can provide a variety of Internet-services to a user of the vehicle, and/or wireless communication systems (e.g., Bluetooth® systems) configured to interface with devices located in or near the vehicle (e.g., a mobile phone). In view of the many interconnected components, systems, and devices commonly included in vehicles, vehicles may be viewed as connected or networked devices.

While connected vehicles offer many benefits, their interconnectivity has potential downsides. For example, the various communication channels between components, systems, and devices included in and associated with a vehicle may be used as pathways to launch malicious attacks against the vehicle (e.g., hacking an engine starting system or the like). In addition, access to and/or distribution of personal information generated by systems in a vehicle by unauthorized parties may be extremely damaging to users of the vehicle. Accordingly, systems and methods that facilitate a security and trust architecture in a connected vehicle are desirable.

Embodiments of the systems and methods disclosed herein facilitate a security and trust architecture in networked or connected vehicles. In certain embodiments, a method for creating a trusted architecture in a connected vehicle may include generating a connected vehicle ecosystem map including information relating to a plurality of electronic control units and network connections included in the connected vehicle. Electronic control units in the vehicle may include, without limitation, a telematics system, an infotainment system, an engine control module, and/or any other processor or logic-based system included in the vehicle and/or any embedded system that controls one or more systems and/or subsystems in a vehicle. Based on the vehicle ecosystem map, trusted relationships involving electronic control units may be identified.

Trusted credentials may be generated and issued to appropriate electronic control units that meet one or more trust requirements. In some embodiments, the trust requirements may comprise software and/or hardware requirements (e.g., secure software and/or secure hardware requirements). Trusted credentials may comprise, without limitation, one or more trusted digital certificates (e.g., X.509 certificates), cryptographic keys, and/or any other indicia of trust configured to facilitate trusted communication between vehicle control units and/or associated systems and devices. Trusted credentials may be used by the electronic control units to facilitate trusted communication between entities included in the connected vehicle ecosystem map.

### BRIEF DESCRIPTION OF THE DRAWINGS

The inventive body of work will be readily understood by referring to the following detailed description in conjunction with the accompanying drawings, in which:

FIG. 1 illustrates an exemplary architecture for a connected vehicle consistent with embodiments of the present disclosure.

FIG. 2 illustrates an exemplary system for issuing one or more trusted credentials to systems included in a connected vehicle consistent with embodiments of the present disclosure.

FIG. 3 illustrates an exemplary trusted architecture for a connected vehicle consistent with embodiments of the present disclosure.

FIG. 4 illustrates an exemplary boundary of trust associated with a connected vehicle consistent with embodiments of the present disclosure.

FIG. 5 illustrates an exemplary system for issuing one or more cryptographic keys to systems included in a connected vehicle consistent with embodiments of the present disclosure.

FIG. 6 illustrates an exemplary system for exchanging cryptographic messages consistent with embodiments of the present disclosure.

FIG. 7 illustrates an exemplary architecture for generating, transmitting, and managing policy information associated with a connected vehicle consistent with embodiments of the present disclosure.

FIG. 8 illustrates exemplary policy enforcement consistent with embodiments of the present disclosure.

FIG. 9 illustrates a flow chart of an exemplary method of generating a trusted credential consistent with embodiments of the present disclosure.

FIG. 10 illustrates a flow chart of an exemplary method of communicating between systems associated with a vehicle consistent with embodiments of the present disclosure.

FIG. 11 illustrates a flow chart of an exemplary method of enforcing a policy consistent with embodiments of the present disclosure.

FIG. 12 illustrates an exemplary system that may be used to implement embodiments of the systems and methods disclosed herein.

### DETAILED DESCRIPTION

A detailed description of systems and methods consistent with the inventive body of work is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to the drawings, wherein like parts may be designated by like numerals. The components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of any method disclosed herein do not necessarily need to be executed in any specific order, or even sequentially, nor need the steps be executed only once, unless otherwise specified.

Systems and methods are presented for facilitating a secure and trusted architecture in networked or connected vehicles. In certain embodiments, the systems and methods described herein can, for example, be used in connection with security and/or digital rights management (“DRM”) technologies such as those described in commonly assigned, co-pending U.S. patent application Ser. No. 11/583,693, filed Oct. 18, 2006, and published as Publ. No. 2007/0180519 A1 (“the '693 application”), U.S. Pat. No. 5,892,900 (“the '900 patent”), U.S. Pat. No. 6,157,721 (“the '721 patent”), and/or service orchestration or DRM technologies such as those described in commonly assigned U.S. Pat. No. 8,234,387 (“the '387 patent”) (the contents of the '693 application and the '900 patent, '721 patent, and '387 patent hereby being incorporated by reference in their entireties) as well as in other contexts. It will be appreciated that these systems and methods are novel, as are many of the components, systems, and methods employed therein.

Networked or connected vehicles offer many features and functions. For example, connected vehicles that include Internet-based services can collect operating and/or performance metrics from the vehicle or its driver and provide such information to third parties (e.g., vehicle manufacturers, insurance companies, vehicle repair centers and the like). This information may be used to help manufacturers track vehicle performance, to provide incentives for good driving habits, to notify users of possible maintenance issues, and/or the like.

Electric vehicles (“EVs”) may benefit from network connectivity in a number of ways. For example, an EV may transmit performance information to a manufacturer relating to the operation of battery and energy recovery systems under various driving conditions, including different climates, elevations, and along routes having certain changes in elevation. The manufacturer may use this performance information in monitoring, characterizing, and optimizing the performance of the EV. A driver of an EV may benefit from information regarding charging station availability and more accurate driving range information. Moreover, a connected EV may be capable of authenticating itself and/or its owner to an electric grid, which may help enable a number of business models for time of use and clean energy based power.

Connected vehicles may also represent new opportunities for marketers and e-retailers. Many advertisers view vehicle occupants as key targets, as they may be a captive audience of music, video, and/or games played in a vehicle or may desire access to travel-related services which may be recommended or promoted by such advertisers. Vehicle manufacturers may integrate “app stores” into their connected vehicles through, for example, in-vehicle infotainment (“IVI”) systems. Through the “app stores”, vehicle occupants may purchase software applications to execute on IVI systems or other vehicle systems. Many vehicles may also include systems that connect to an occupant's mobile phone or other computing device (e.g., via Bluetooth® pairing). Connecting a vehicle to a mobile device, however, may expose certain vehicle systems to third parties accessing a wireless communication pathway of the mobile device and/or a panoply of unvetted third party applications executing on the driver's phone, each of which may launch malicious attacks against the vehicle or make unintended or undesirable use of related data.

While connected vehicles open the door to a universe of safer and happier drivers, many systems associated with connected vehicles may turn a vehicle into an extensive repository of private information about vehicle occupants. A hack or other malicious attack into data repositories containing private information associated with a vehicle or its occupants may be damaging to such occupants. For example, private information associated with a vehicle's occupants could be illicitly sold and/or used against the occupants for a variety of malicious or unwanted purposes.

Embodiments of the systems and methods disclosed herein facilitate a security and trust architecture in connected vehicles. In certain embodiments, protecting a vehicle's systems, ensuring overall road safety, and/or protecting vehicle occupant privacy can be achieved. For example, embodiments disclosed herein may ensure that systems, components, and devices included in a vehicle are authenticated, that third party software and/or hardware is trusted before being admitted to a vehicle execution environment, that personal information generated by the vehicle is handled in a manner that is policy managed and protected by access control technologies, that third party services that interact with the vehicle are trusted and policy managed, that a standard and open trust management architecture certifies components of the secure system, and/or that the overall architecture has a renewable security system. The connected vehicle exists as part of a larger ecosystem that includes external services, individuals who may have access to the services, other vehicles, and the entire vehicle manufacturing supply and support chain. Embodiments disclosed herein may be used in understanding and analyzing this ecosystem to facilitate an overall security and trust architecture.

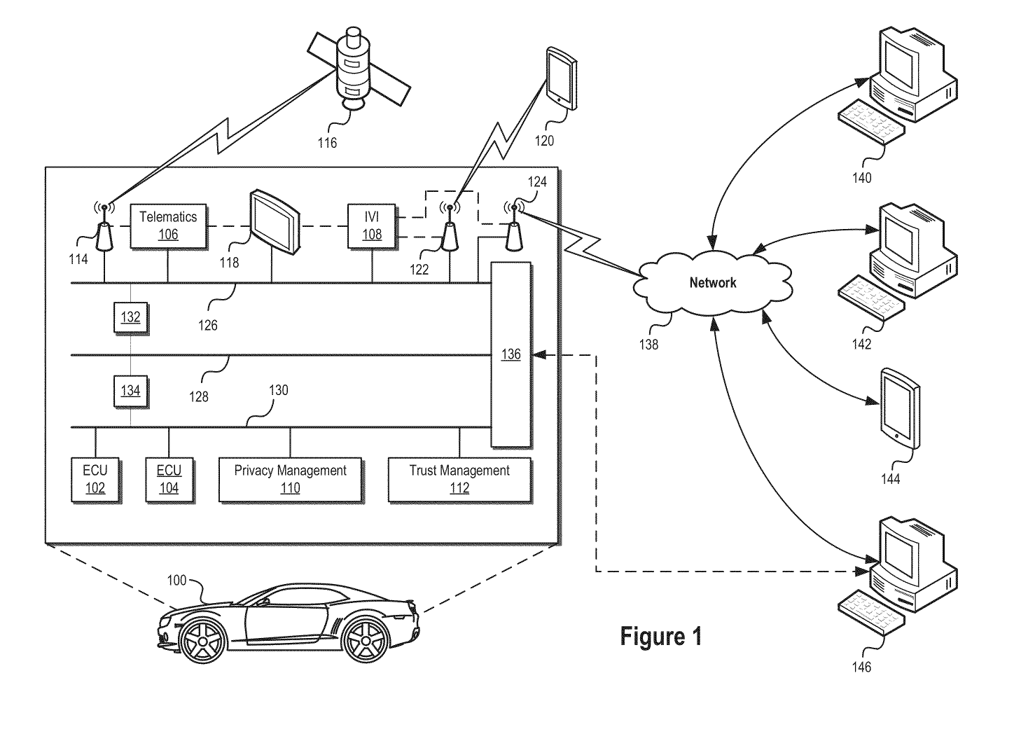

FIG. 1 illustrates an exemplary architecture for a connected vehicle 100 consistent with embodiments of the present disclosure. More specifically, FIG. 1 illustrates a connected vehicle 100 (e.g., an automobile, truck, or any other suitable vehicle) and an associated ecosystem consistent with embodiments disclosed herein. Systems, components, and devices included in the illustrated architecture are described in more detail below.

Electronic Control Units

As illustrated, the vehicle may include one or more Electronic Control Units (“ECUs”) 102-104. As used herein, an ECU 102-104 may be any processor or logic system included in a vehicle 100 and/or any embedded system that controls one or more systems and/or subsystems in a vehicle 100. Various ECUs 102-104 may be incorporated in a vehicle 100 including, for example, some or all of:
Electronic/Engine Control Modules (“ECMs”)
Powertrain Control Modules (“PCMs”)
Transmission Control Modules/Units (“TCMs” or “TCUs”)
Brake Control Modules (“BCMs” or “EBCMs”)
Convenience Control Units (“CCUs”)
Central Timing Modules (“CTMs”)
General Electronic Modules (“GEMs”)
Body Control Modules (“BCMs”)
Suspension Control Modules (“SCMs”)
Central Control Modules (“CCMs”)
Electric Power Steering Control Units (“PSCU”)
Door Control Units (“DCUs”)
Speed Control Units (“SCUs”)
Telematics Systems and Telematics Control Units
In-Vehicle Infotainment Systems

Many functions of the vehicle 100 may be monitored and/or controlled by an ECU 102-104 or an associated system. In certain embodiments, certain ECUs 102-104 included in the vehicle 100 may be associated with one or more sensor systems configured to measure operating information and/or parameters related to the vehicle 100. In further embodiments, ECUs 102-104 may include or be associated with one or more control systems configured to control certain functions or features of the vehicle 100 (e.g., electrical switches, mechanical actuators or valves, and/or the like). ECUs 102-104 may be configured to provide control signals and status information to other ECUs 102-104, and correspondingly to respond to control signals and status information provided by other ECUs 102-104.

In certain embodiments, the vehicle 100 may include a telematics system 106. The telematics system 106 may perform a variety of functions. In certain embodiments, the telematics system 106 may be communicatively coupled with a Global Positioning System (“GPS”) transceiver 114 configured to communicate with and receive location information from a satellite navigation system 116. Location information received from the satellite navigation system 116 may be displayed to occupants of the vehicle 100 via a display 118 coupled to the telematics system 106. In certain embodiments, the telematics system 106 may comprise an OnStar® system, a Lexus Link® system, a BMW Assist® system, and/or any other suitable telematics system by any telematics service provider or manufacturer.

The telematics system 106 may further be configured to collect information from one or more systems of the vehicle 100, to control and/or interact with one or more systems of the vehicle 100 (e.g., a vehicle starter system), to collect and/or provide information useful to a user of the vehicle (e.g., navigational position information) or third party services, and/or to provide any other suitable telematics-related functions. For example, the telematics system 106 may allow a user to remotely start the vehicle 100 or unlock/lock the doors of the vehicle 100 from a device associated with the user. Further, the telematics system 106 may communicate information relating to the vehicle 100 to its occupants including, for example, information related to a specific point of interest in response to a request from a user (e.g., location and/or mapping lookup) and/or vehicle status information (e.g., battery charge levels). Further, the telematics system 106 may provide automatic collision notification to relevant governmental authorities and/or service provider representatives. In some embodiments, the telematics system 106 and/or another system may be coupled to radar, optical, photographic and/or other sensors to monitor and process information regarding the immediate surroundings of the vehicle and use this information to facilitate automatic and/or assisted steering and acceleration of the vehicle (e.g., a self-driving or driverless vehicle).

The vehicle 100 may further include an IVI system 108. The IVI system 108 may include any suitable combination of systems, components, and/or devices to, among other functions, provide audio, visual, and/or audio/visual entertainment services to vehicle occupants, to provide Internet-based services to vehicle occupants, and/or to interface with one or more devices associated with vehicle occupants. For example, the IVI system 108 may be configured to communicate with a mobile device 120 (e.g., via an intra-vehicle wired or wireless communication transceiver 122) associated with a vehicle occupant. In further embodiments, the IVI system 108 may be configured to interface with an “app store” where vehicle occupants may purchase software applications to execute on the IVI system 108 or other vehicle systems. Although the IVI system 108 is illustrated as separate from the telematics system 106, in certain embodiments, functionality of the telematics system 106 and the IVI system 108 may be incorporated in a single system, in one or more separate systems, or in any other suitable configuration.

The vehicle 100 may further include a trust management system 112 and/or a privacy management system 110. The trust management system 112 may implement trust management functions, including functions relating to vehicle system, component, and device credentialing, trusted communication, authentication, authorization, key management, and/or the like. The privacy management system 110 may be configured to implement privacy management functions, including functions relating to protecting personal information associated with the vehicle 100 and/or its occupants and implementing privacy management policies. Although the trust management system 112 and the privacy management system 110 are illustrated as separate systems, in further embodiments some or all of the functionalities of the trust management system 112 and/or the privacy management system 110 may be incorporated in a single system, integrated with other systems (e.g., the telematics system or the IVI system), and/or arranged in any other suitable configuration.

Network Connections

The system, components, and devices included in and/or associated with the vehicle 100 may be communicatively coupled using a variety of suitable communication networks and/or communication technologies. Network connections may include intra-vehicle communication networks and inter-vehicle networks. In certain embodiments, intra-vehicle networks may use one or more communication busses 126-130 to communicatively couple systems, components, and devices included in the vehicle 100. In certain embodiments, certain vehicle systems (e.g., safety-related systems) may be isolated on their own communication bus. For example, braking and/or transmission control ECUs may be included on a discrete communication bus. The communication busses 126-130 may be interconnected using one or more communication gateways 132-134 facilitating communication across the busses 126-130. In some embodiments, communication gateways 132-134 may be used to implement trusted communication and policy management techniques for managing information communicated between communication busses 126-130 disclosed herein (e.g., using firewalls and/or the like).

In some embodiments, the communication busses 126-130 may include one or more controller area network (“CAN”) busses and be capable of communicating using the CAN bus protocol and/or variants thereof. In further embodiments, the communication busses 126-130 may include one or more media oriented systems transport (“MOST”) busses and be capable of communicating using the MOST bus protocol and/or variants thereof. In certain embodiments, systems, components, and/or devices included in the vehicle 100 may be communicatively coupled without intermediate communication busses 126-130. For example, as illustrated, the telematics system 106 may be directly coupled to the GPS transceiver 114 and/or the display 118.

The intra-vehicle networks may further include one or more intra-vehicle wireless communication networks. For example, certain vehicle sensor systems, including tire pressure monitoring sensor systems, may be configured to communicate with ECUs included in the vehicle 100 via wireless communication channels using any suitable wireless communication technology. In certain embodiments, the vehicle may further include an intra-vehicle wireless communication transceiver 122 configured to communicate with devices (e.g., mobile device 120) associated with vehicle users. For example, using the intra-vehicle wireless communication transceiver 122, a mobile phone 120 may be paired with an IVI system 108 of the vehicle 100 (e.g., using Bluetooth® or the like).

Inter-vehicle networks may use one or more wireless and/or wired communication technologies (it should be understood that the term “inter-vehicle” network is used herein to refer generally to any network that connects the vehicle to the external world, and is not limited to networks that may, for example, connect the vehicle to another vehicle). Inter-vehicle networks may allow one or more external systems or devices 140-146 to communicate with systems, components, or devices included in the vehicle 100. In some embodiments, the vehicle 100 may include an inter-vehicle wireless communication transceiver 124 configured to facilitate inter-vehicle wireless communication with a network 138 (e.g., the Internet, a cellular telephone network, or other network), using any suitable communication protocol or protocols. In certain embodiments, the intra-vehicle and/or inter-vehicle wireless networks may comprise wireless carrier systems, such as a personal communications system (“PCS”), a global system for mobile communication, and/or any other suitable communication system incorporating any suitable communication standards and/or protocols. In further embodiments, the intra-vehicle and/or inter-vehicle wireless networks may include an analog mobile communications network and/or a digital mobile communications network utilizing, for example, code division multiple access (“CDMA”), Global System for Mobile Communications or Groupe Speciale Mobile (“GSM”), frequency division multiple access (“FDMA”), and/or time divisional multiple access (“TDMA”) standards. In certain embodiments, the intra-vehicle and/or inter-vehicle wireless networks may incorporate one or more satellite communication links (not shown). In further embodiments, the intra-vehicle and/or inter-vehicle wireless networks may use IEEE's 802.11 standards, Bluetooth®, ultra-wide band (“UWB”), Zigbee®, near-field communication (“NFC”) technology, and or any other suitable standard or technologies.

Inter-vehicle and/or intra-vehicle wired and/or wireless communication networks may include one or more communication interfaces configured to enable external systems to communicate with systems, components, and devices of the vehicle 100. For example, the vehicle 100 may include a diagnostic port 136 (e.g., an on-board diagnostic (“OBD”) port) configured to facilitate vehicle diagnostic and reporting capabilities. In certain embodiments, the diagnostic port 136 may be communicatively coupled with one or more communication busses 126-130 associated with one or more ECUs included in the vehicle. A diagnostic system 146 may be configured to couple with diagnostic port 136 and provide a vehicle owner or repair technician access to state of health information for various systems, components, and devices in the vehicle 100. For example, a diagnostic system 146 interfacing with the diagnostic port 136 may be provided real-time data relating to the vehicle 100 as well as one or more standardized diagnostic trouble codes (“DTCs”) that may allow a vehicle owner or repair technician to rapidly identify and remedy issues within the vehicle 100.

Software

The systems, components, and devices included in and associated with the vehicle 100 may include various software applications and/or execution environments. Various software applications and/or execution environments included in and associated with the vehicle 100 may be developed by different software providers. Further, software applications and/or operating environments executing on the various systems, components, and/or devices may be unaware of software applications and/or operating environments operating in different systems, components, and/or devices. Moreover, as discussed above, the IVI system 108 may be configured to interface with an “app store” where vehicle occupants may obtain (e.g., purchase) and download software applications to execute on the IVI system 108 and/or other vehicle systems. Software implementations may incorporate features to facilitate trust and privacy management methodologies consistent with embodiments disclosed herein. For example, software implementations may enable various execution environments including secure execution environments. Additionally, software implementations may enable device credentialing, trusted communication, authentication, authorization, key management, and policy management and enforcement functionalities as disclosed herein.

In some embodiments, the privacy management system 110 and/or trust management system 112 may include DRM and/or other security software for enforcing policies associated with access to and/or other use of other vehicular software, systems, and/or data. For example, in some embodiments the privacy management system 110 and/or trust management system 112 may include a DRM engine and/or trusted execution environment such as that described in the '693 application, the '900 patent, the '387 patent, and/or the '721 patent.

In certain embodiments, the systems and methods disclosed herein may be included in a system, component, and/or device implementing the Automotive Open System Architecture (“AUTOSAR”) and/or any variant thereof. Authentication and authorization protocols consistent with embodiments disclosed herein may be implemented in a layer comprising one or more AUTOSAR interfaces. In further embodiments, cryptographic support and policy management consistent with embodiments disclosed herein may be implemented in software layers under an AUTOSAR runtime environment (“RTE”).

Connected Devices

Various systems and devices may be connected to the vehicle 100 via intra-vehicle and/or inter-vehicle communication networks. For example, the IVI system 108 may be configured to communicate with a mobile device 120 associated with a vehicle occupant (e.g., via Bluetooth® pairing or the like). Further, intra-vehicle and/or inter-vehicle communication networks may allow one or more external systems or devices 140-146 to communicate with systems, components, or devices included in the vehicle 100. The connected systems and devices may comprise a variety of computing devices and systems, including laptop computer systems, desktop computer systems, sever computer system, smartphones, feature phones, tablet computers, wireless control devices (e.g., keyless entry or remote start devices), and/or the like. For example, in certain embodiments, a smartphone or other device 144 may interface with the vehicle 100 via the network 138 and control certain vehicle functions remotely (e.g., a starter motor).

In certain embodiments, connected devices may include trusted and/or secure hardware components that facilitate the trust and privacy management methodologies disclosed herein. For example, connected devices may include secure processing components and/or environments (e.g., such as those described, for example, in the '900 patent) configured to implement the trust and privacy management methodologies disclosed herein. Connected devices may further include hardware configured to implement device credentialing, trusted communication, authentication, authorization, key management, policy management and enforcement, and/or the like.

Services

A variety of services may interact and/or communicate with the vehicle 100 and its constituent systems, components, and/or devices. In certain embodiments, the services may be provided, at least in part, by one or more communicatively coupled external systems or devices 140-146. Examples of services may include, without limitation, GPS-based navigation, traffic, weather and travel information services, entertainment services, information services, services offered by or on behalf of vehicle charging infrastructure providers, Internet-based services (e.g., entertainment and/or software applications), and/or services that involve human agents (e.g., manufacturing supply chain personnel, maintenance personnel, and vehicle owners, drivers, and occupants).

As illustrated, a service may be implemented, at least in part, by a service provider system 140 configured to interact with systems, components, and/or devices included in the vehicle 100 via the network 138. Certain trust and privacy management services may be implemented, at least in part, by a trust and privacy management system 142 that may facilitate device credentialing, trusted communication, authentication, authorization, key management, and/or policy management and enforcement operations as disclosed herein. For example, in certain embodiments, the trust and privacy management system 142 may act as a root of trust, issuing trust credentials to trusted systems, components, and devices included in the vehicle 100 and/or other trusted services. Further, the trust and privacy management system 142 may generate and distribute to the vehicle 100 policy management information used in protecting policy managed information (e.g., personal information relating to a user of the vehicle 100). Although illustrated as a single system, trust and privacy management functionalities may be performed by any other suitable system or combination of systems.

Connected vehicle ecosystem design and deployment may involve coordination of various constituent systems, components, devices, and services in the context of the design and manufacture of the vehicle 100. This may include assuring compliance with internal product requirements and budget constraints, industry regulations, governmental regulations, safety and security criteria, and/or software design requirements and testing criteria. Consistent with embodiments disclosed herein, trust and privacy management implementation methodologies may analyze the connected vehicle ecosystem while taking these constraints and criteria into account, together with the complexity of the ecosystem supply chain.

Connected Vehicle Risks

As discussed above, various systems, components, and devices included in and associated with the vehicle 100 may collect information relating to the vehicle 100 that, in certain circumstances, may be personal or confidential information. For example, systems in the vehicle 100 and associated services may collect personally identifiable information (“PII”) relating to vehicle occupants, energy use of the vehicle 100, driving habits of a driver of the vehicle 100, and/or the like. Unauthorized access and/or distribution of such PII may be damaging to users of the vehicle. Accordingly, consistent with embodiments disclosed herein, PII generated by the vehicle 100 may be handled in a manner that is policy managed and/or protected by access control technologies.

A connected vehicle 100 may be designed such that control signals can be sent from services and/or devices external or internal to the vehicle 100 and/or an ECU in the vehicle 100. For example, a smartphone or other device 144 may interface with the vehicle 100 via the network 138 and control certain vehicle functions remotely (e.g., a starter motor). Such services, their associated network connections, and transmitted control information or messages may be exposed to either malicious or coincidental tampering, resulting in unauthorized control messages being sent to the vehicle 100 and/or an ECU in the vehicle 100. Malicious attacks on the vehicle 100 may include, without limitation, denial of service attacks, manipulation of climate controls, eavesdropping via microphones internal to the vehicle, attacks directed to draining battery systems, introduction of malware, and/or any other attack launched against the vehicle 100 or its constituent systems. Additional attacks may include direct tampering with intra-vehicle information systems designed to place the vehicle 100 in an unsafe condition.

Points of Attack

Due to the nature of connected vehicles, malicious attacks against a vehicle 100 may not be limited to attacks requiring intra-vehicle or near-vehicle access. For example, remote attacks may be launched giving an attacker control of vehicle functions controlled by one or more ECUs. Attacks may be mounted from the Internet and be directed to a specific vehicle or a group of vehicles. Prior to the use of computerized controllers and remote network connections in vehicles, vehicle hardware and/or software were not necessarily designed with the prevention of electronic malicious attacks in mind. As the vehicle is now a connected entity that exists in cyberspace much like any other computation node, computer, tablet, or smartphone, security risks to the vehicle against malicious attacks may be launched from within the vehicle, near the vehicle, or over the Internet or other network at large. Accordingly, systems and methods disclosed herein may enable a trust and privacy management architecture protecting a vehicle against malicious attacks launched from a variety of locations.

Various access locations from which malicious attacks against a vehicle may occur include, without limitation the following:
Direct physical access (e.g., using an OBD-II port, physical access to ECUs and intra-vehicle communication busses, and the like)
Near-field wireless access (e.g., access via a Bluetooth® system, tire pressure monitoring system, remote keyless entry and start systems, and the like)
Long distance wireless access (e.g., access to a telematics system providing safety, security, and location services, mobile telephony systems, IVI systems, and systems interacting with Internet-based services)

In certain circumstances, successful attacks launched from the above-described locations may result in access to and control of ECU controlled systems included in the vehicle.

An individual launching a malicious attack against a vehicle may have a variety of underlying motivations including, without limitation, the following:
Access to and theft of PII relating to the driver of a vehicle or its occupants (e.g., information regarding an individual's location, financial information, conversations within the vehicle, general habits, and the like)
Control and/or theft of a vehicle and/or its constituent systems (e.g., access to intra-vehicle control functions providing a means to interfere with systems monitors, override security functions, tamper with safety functions including air bag systems, throttle governors, electronic braking, interfere with battery charging, interfere with automatic driving systems, and/or the like)
Access to long distance vehicle communication channels (e.g., access to safety and security services communication data, GPS tracking information, mobile telephone systems, and the like)

Systems and methods disclosed herein may enable a trust and privacy management architecture protecting a vehicle against attacks motivated by a variety of malicious reasons.

Connected Vehicle Ecosystems

In certain embodiments, systems and methods disclosed herein may be implemented in a manner recognizing that the vehicle is part of a larger ecosystem. Gaining an understanding of the security effects that each component of the ecosystem has on other components may be used to create a trusted environment. To facilitate security and safety within connected vehicle ecosystems, communication and processing elements may be capable of establishing a trust relationship with the processing elements upon which they support or rely. This may extend to other participants in the ecosystem including, without limitation, vehicle manufacturers, vehicle owners, vehicle technology component providers, and vehicle service providers.

In certain embodiments, establishing a trusted architecture may account for some or all of the following ecosystem participants and components:
Ecosystem stakeholders—These may include, without limitation, vehicle manufacturers, vehicle owners, drivers, and occupants, vehicle technology component providers, vehicle maintenance and repair personnel, vehicle support service providers, IVI service providers, and application providers (e.g., downloadable application providers).
Internal and external supply chains—Security and trust management methodologies disclosed herein may involve understanding relationships among technology components provided from different sources, how adversaries and intruders can affect or attack those components, and how such attacks can create downstream effects on other components.
Technology components—These may include, without limitation, ECUs, interfaces between ECUs, and the software and systems based on or running within ECUs.
Network connections used for communication among technology components.
Inter-dependencies among technology components.
External services that interface with internal components.
Accessibility of components to various ecosystem stakeholders.
Privacy, confidentiality, and usage rules—These may include, without limitation, policies and rules associated with data sent from the vehicle to various networked services.

Connected Vehicle Ecosystem Map

In certain embodiments, the above-described ecosystem participants may be identified and used to develop an ecosystem map. Based on the ecosystem map, a determination may be made as to which components are trusted to interact with other components and under what terms. For example, it may be determined whether a telematics system is allowed to communicate with a tire pressure monitoring system, whether such an interaction is bilateral, and/or whether the interaction involves control systems or is limited to providing status signals to the telematics system to notify a vehicle driver. Based on this information, trust relationships between ecosystem participants may be identified and, consistent with systems and methods disclosed herein, ways in which these trusted relationships could be enforced may be determined.

In certain embodiments, developing a connected vehicle ecosystem map may include, without limitation:
Identifying and analyzing vehicle sensors and ECUs.
Identifying ECU manufacturers, functions, interface specifications, software and related renewal and debugging processes and dependencies on and communication with other ECUs.
Identifying what data is exchanged.
Identifying which participants have access to ECUs and through what channels.
Identifying and analyzing intra-vehicle and inter-vehicle communication networks including, for example, ECU-to-ECU networks, wired and wireless networks, and ECU-to-external service provider networks.
Identifying external services and service providers and what services interface with the vehicle.
Identifying entities that will act upon and require access to resources and/service providers and how such access is facilitated.
Identifying what entity or entities vouch for other entities and their access to ecosystem elements (e.g., identifying “roots of trust” within an ecosystem).

In developing a connected vehicle ecosystem map, resource and entity functionalities may be considered and/or classified. For example, certain resources and/or entities may be identified as being important for vehicle safety. Similarly, resources and/or entities may be classified as being associated with entertainment functionalities, communication functionalities, telematics functionalities, infotainment functionalities, and/or any other suitable resource and/or entity functionality.

In certain embodiments, the connected vehicle ecosystem map may articulate, among other things, which entities are authorized to access which resources and for what purposes (e.g., read only access, write access, software update access, etc.), what entity or entities authorize such access, how communication between entities and resources can be protected (e.g., encrypted, authenticated, confidentiality protected, etc.), and/or the like.

The connected vehicle ecosystem map may also include an indication as to what extent component certification processes can be created or modified to include secure software practices. For example, such processes might certify that ECU interfaces have been designed taking into account the other entities that might be accessing the ECU, thereby avoiding interfacing errors such as potential buffer checking/overflow errors, and/or the like. The map may further reflect robustness criteria for entities and/or resources.

Trust Management

Trust management methodologies disclosed herein may analyze ecosystem participants and implement methods for establishing trust and securing interaction between such participants. To establish appropriate trust management methodologies, one or more of the following may be analyzed:
What principals are involved in the ecosystem, how they are identified, and what mechanisms should be used so that principal identities can be trusted.
What ecosystem resources need to be governed and protected and what mechanisms should be used to do so.
What principals are authorized to access which resources and for what purposes (e.g., principle X is allowed Y access to resource Z).
What entities are trusted to set policy around resource usage, ecosystem principles, and overall ecosystem deployment and management. That is, what entity or entities act as roots of trust or as trust authorities.
How are security and privacy polices articulated, communicated to relevant stakeholders, and enforced.

In certain embodiments, an analysis of appropriate trust management methodologies may be focused on vehicle interactions (e.g., internal and external interactions) including, without limitation, data that is collected by intra-vehicle sensors, entities that request/require access to the data, and/or the channels used to communicate the data among authorized entities. This data may be communicated to ECUs included in a vehicle or to services (e.g., Internet-based services) that are responsible for translating received data into control or information signals designed to support the vehicle operator, network services, or to control the vehicle. Principals involved in such an ecosystem may include technical components—e.g., sensors, control units, network interfaces, service support infrastructure, and the like—as well as humans with access to the vehicle and services with which it is associated—e.g., vehicle operators, manufacturing and maintenance personnel, extra-vehicle infotainment and support services personnel, and the like.

In further embodiments, an analysis of appropriate trust management methodologies may involve use of tools to implement authorization, authentication, and confidentiality for resources and network connection communication protocols. Hardware and/or software capabilities of the systems, components, and devices included in and/or associated with the vehicle may also be considered. For example, some ECUs may not have the computing power to implement complex public key signature and/or decryption methodologies. Accordingly, trust and privacy management methodologies may be used for each resource appropriate to its authorization, authentication, and confidentiality requirements as well as its capabilities (e.g., computational capabilities).

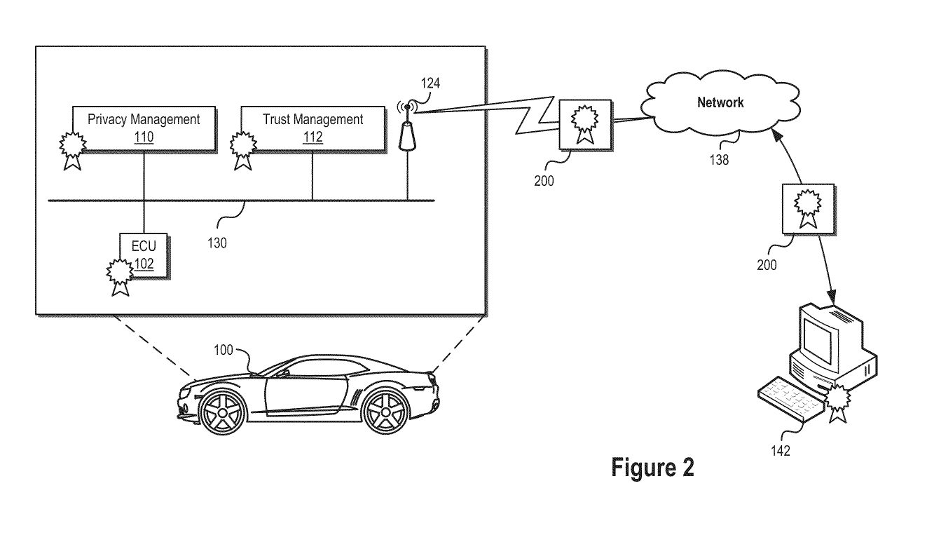

In certain embodiments, systems and methods disclosed herein may use trusted credentials and/or certificates issued by a trusted authority to implement and enforce trust management architectures. FIG. 2 illustrates a system for issuing one or more trusted credentials 200 to systems included in a connected vehicle 100 consistent with embodiments of the present disclosure. As used herein, the terms credential and certificate may be used interchangeably.

A trusted credential 200 or other indicia of trust may be issued by a trusted authority operating as a root of trust. In certain embodiments, the trusted authority may be a centralized trust and privacy management system 142 implementing a variety of functions including, without limitation, device credentialing, trusted communication, authentication, authorization, key management, and/or policy management and enforcement operations. Trust and privacy management system 142 may act as a root of trust, issuing trust credentials to trusted systems, components, and devices included in and associated with the vehicle 100 and/or other trusted services and devices. Although illustrated as a single system, trust and privacy management functionalities may be performed by any other suitable system or combination of systems.

In certain embodiments, trusted credentials 200 may be issued by a plurality of trusted authorities. A trusted authority may be associated with content provider, an industry association of vehicle manufacturers, a governmental or regulatory body, a consumer protection organization, a network security firm, a digital rights management provider, a vehicle service provider, and/or any other suitable entity with an interest in ensuring trusted communication between a vehicle and its constituent components and connected devices and services.

Prior to issuing a trusted credential 200, the trust and privacy management system 142 may verify (e.g., certify) that systems, components, and devices included in and associated with the vehicle 100 are trusted. In certain embodiments, such trust verification may include determining that a system, component, or device included in or associated with the vehicle 100, or software or hardware components included therein, meets certain security requirements. For example, prior to issuing a trusted credential to a service provider system, the trust and privacy management system 142 may require that the service provider system include a secure processor system and/or incorporate a secure execution environment for handling secure information.

After verifying a system, component, or device included in or associated with the vehicle 100 meets certain trust and security requirements, the trust and privacy management system 142 may generate and distribute a trusted credential 200 via network 138 to the trusted systems. In certain embodiments, the trusted credential may be generated using any suitable cryptographic techniques (e.g., techniques that use cryptographic hash algorithms). In further embodiments, a trusted credential may comprise a cryptographic key. Any other suitable credential operating as an indicia of trust may also be used. It will be appreciated that there are a variety of techniques for generating a credential or certificate, and that for purposes of practicing the systems and methods disclosed herein, any suitable technique may be used.

Possession of a trusted credential 200 may have certain associated requirements. For example, a system may be required to store a trusted credential 200 in a secure manner so that it is not easily accessible to maintain possession of the trusted credential 200. Aspects of the use of a trusted credential 200 may have similar requirements (e.g., how trusted credentials 200 are used in trusted communications and the like). Such requirements may maintain the trustedness of the trusted credential 200 within the connected vehicle ecosystem, and may help mitigate the potential for the trusted credential 200 to be compromised.

As illustrated, the trust and privacy management system 142 may distribute trusted credentials 200 to certified systems included in the vehicle 100 including, for example, a trust management system 112 and/or a privacy management system 110. In certain embodiments, the trust management system 112 and/or privacy management system 110 included in the vehicle 100 may perform trust certification and trusted credential generation and distribution operations for other systems, components, and devices included in and associated with the vehicle 100. In further embodiments, the external trust and privacy management system 142 may perform trust certification and trusted certificate generation and distribution operations for the systems, components, and devices included in and associated with the vehicle 100. For example, as illustrated, an ECU 102 included in the vehicle 100 that meets certain security and/or trust requirements may be issued a trusted credential 200. Communications generated by the ECU 102 may use the trusted credential 200 such that other trusted systems, components, devices, and services can determine that the communications from the ECU 102 are trusted. For example, communications from the ECU 102 may include information indicating that the ECU 102 possesses a trusted credential 200. A system, component, device, or service receiving the communication may use the information to determine that the ECU 102 and its associated communications are trusted.

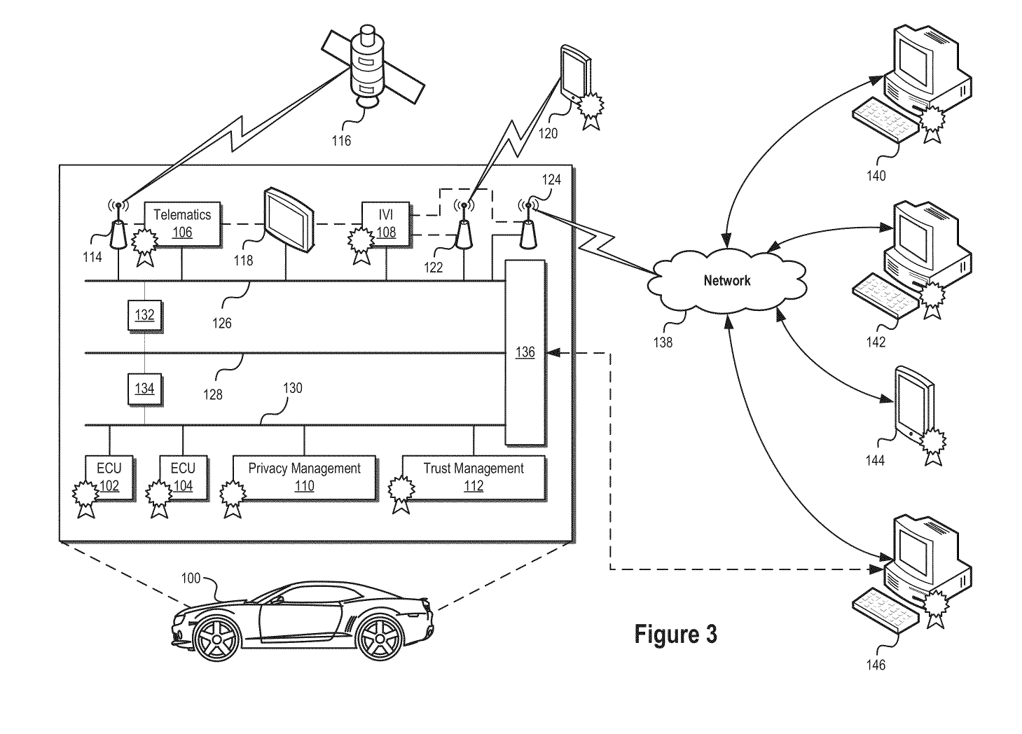

FIG. 3 illustrates an exemplary trusted architecture for a connected vehicle 100 consistent with embodiments of the present disclosure. A trust and privacy management system 142 operating as a trusted authority (e.g., a root of trust) may issue trusted credentials to certified systems, components, and devices included in and associated with the vehicle 100 and/or other trusted services and devices. For example, as illustrated, a variety of ECUs included in the vehicle 100 (e.g., ECUs 102-104, telematics system 106, IVI system 108, privacy management system 110, trust management system 112, etc.), devices associated with the vehicle 100 (e.g., mobile device 120), and systems and devices associated with vehicle services (e.g., service provider system 140, remote device 144, diagnostic system 146, etc.) may be issued trusted credentials. Prior to issuing trusted credentials, the trust and privacy management system 142 may verify and/or certify that systems, components, and devices included in and associated with the vehicle 100 and/or other trusted services and devices meet certain trust and security requirements.

Although not shown, certain network communications devices included in the vehicle 100 may also be issued trusted credentials if certain trust and security requirements are met. For example, communication transceivers and/or gateways may be issued trusted credentials that may be used to indicate to other devices and systems that communications originating from the transceivers and/or gateways should be trusted.

In certain embodiments, which systems, components, and devices included in and associated with the vehicle 100 are issued trusted credentials may be determined based on an ecosystem map. Using the ecosystem map, relationships between ecosystem participants may be identified. For example, trust hierarchies between ECUs may be identified. Based on these identified relationships, devices (e.g., ECUs) that should be included in a trusted architecture may be identified and issued trusted credentials if they meet requisite trust and security requirements. For example, without limitation, in some embodiments a trust management framework such as that described in commonly assigned U.S. Pat. No. 8,104,075, entitled Trust Management Systems and Methods, could be used.

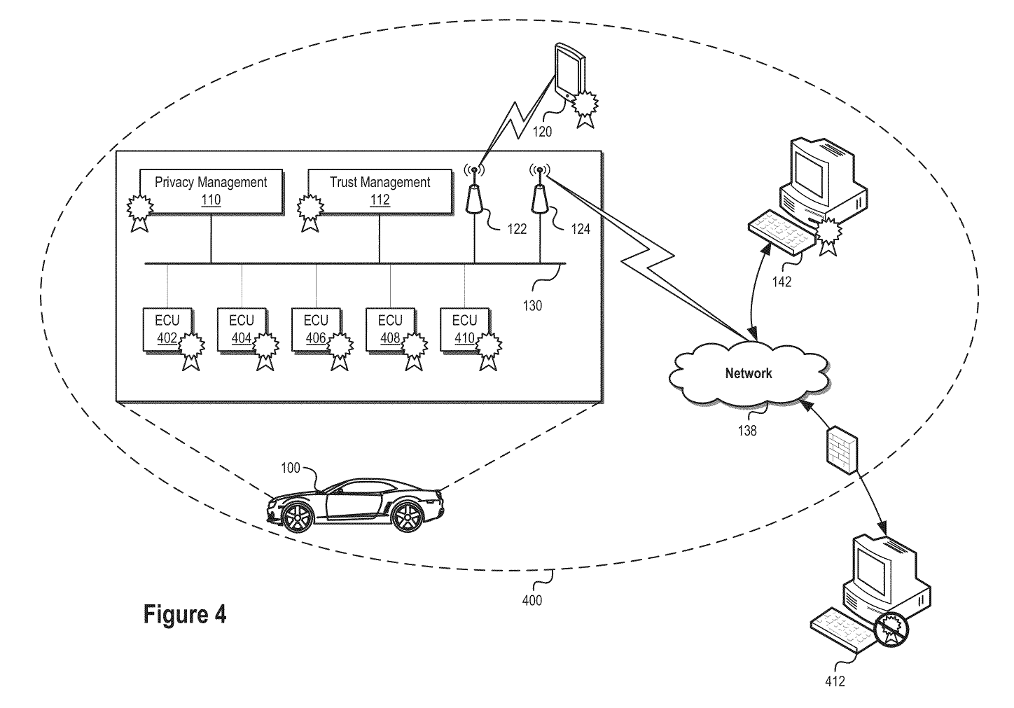

FIG. 4 illustrates an exemplary boundary of trust 400 associated with a connected vehicle 100 consistent with embodiments of the present disclosure. As illustrated, certain systems, components, and devices included in and associated with the vehicle 100 may be trusted and/or certified devices and, accordingly, may possess trusted credentials issued by a trusted authority (e.g., trust and privacy management system 142). Communication between systems, devices, and components possessing trusted credentials may be trusted communications.

An unverified system 412 will not possess trusted credentials issued by a trust authority. Accordingly, communications from the unverified system 412 will originate outside the boundary of trust 400. An unverified system 412 may be used to launch a malicious attack against the vehicle 100. Accordingly, trusted systems, components, and devices included in and associated with the vehicle 100 may disregard communications originating outside the boundary of trust 400. For example, an unverified system 412 may attempt to issue a control instruction to one of trusted ECUs 402-410. The receiving ECU may determine that the communication is untrusted. In certain embodiments, the receiving ECU may determine that the communication is untrusted by determining that the communication does not include an indication that the system originating the communication possesses a trusted credential (e.g., indicia of trust). Based on the lack of indicia that the system originating the communication possesses a trusted credential (e.g., indicating that the system is outside the boundary of trust 400), the receiving ECU may disregard the communication originating from the untrusted system 412. In alternative embodiments, communications from the unverified system 412 may be blocked by other components (e.g., network components) prior to receipt by one of the trusted ECUs 402-410 based on a determination that they arrived from an untrusted source.

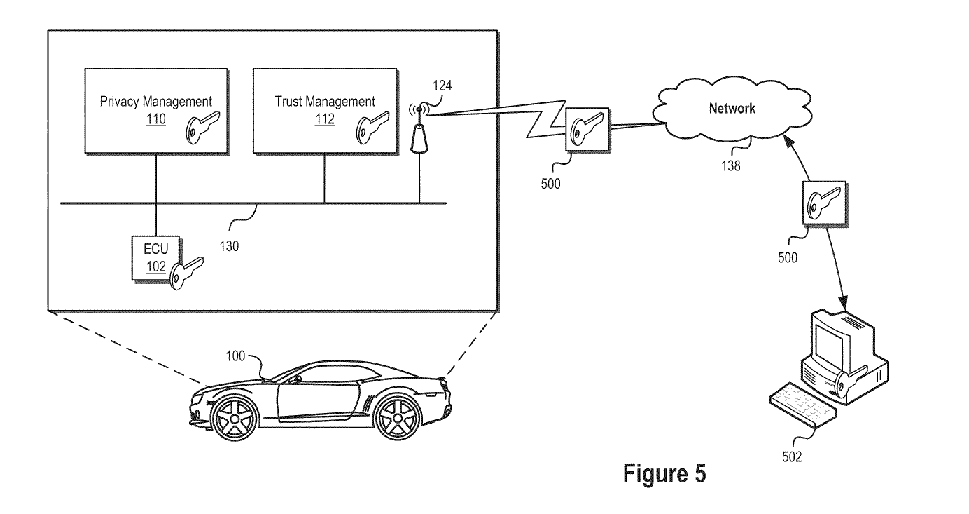

In certain embodiments, a trusted credential may comprise a cryptographic key. FIG. 5 illustrates a system for issuing one or more cryptographic keys 500 to systems included in a connected vehicle 100 consistent with embodiments of the present disclosure. As illustrated, a trusted authority 502, which in certain embodiments may be a trust and privacy management system, may issue one or more cryptographic keys 500 to trusted systems, components, and devices included in or associated with the vehicle 100. Alternatively, or in addition, certain systems, components, and/or devices included in or associated with the vehicle may have keys or other identifying or certification information embedded in their hardware and/or software at the time of manufacture and/or deployment which can be used to facilitate secure communication, authentication, further key exchange or distribution, and/or the like.

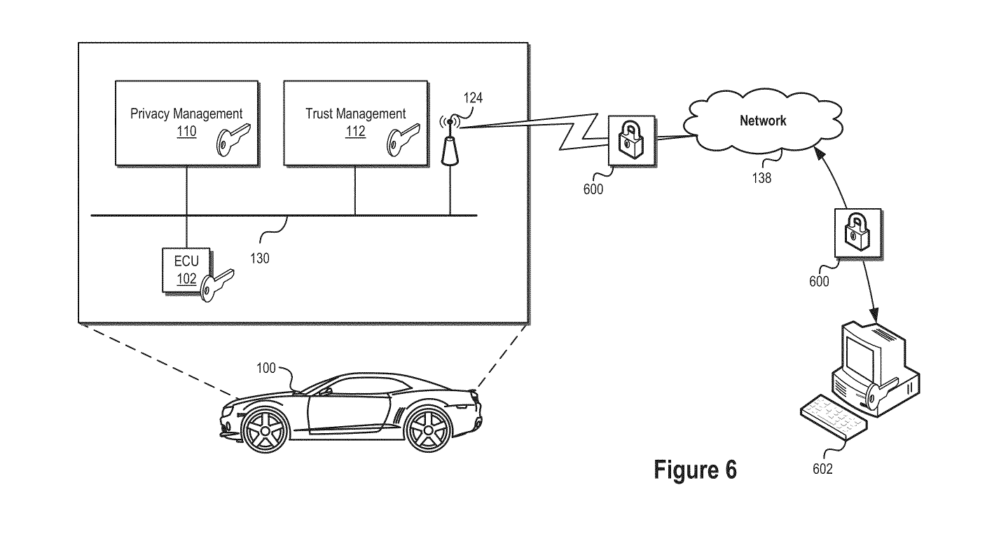

The cryptographic keys 500 may be used in exchanging cryptographic messages between the trusted systems, components, and devices included in and associated with the vehicle 100. FIG. 6 illustrates a system for exchanging cryptographic messages 600 consistent with embodiments of the present disclosure. As illustrated, messages originating from trusted systems, components, and devices included in and associated with the vehicle 100 may be encrypted and/or digitally signed using one or more cryptographic keys (e.g., a key of a public-private cryptographic key pair). Trusted systems receiving the encrypted and/or signed messages 600 may use complementary cryptographic keys to, for example, decrypt, and/or verify the signature associated with, the messages. For example, a trusted service provider system 602 possessing a cryptographic key may encrypt a message and transmit the encrypted message 600 to an ECU 102 via the communications network 138. Being a trusted system, the ECU 102 may possess a complementary cryptographic key that it may use to decrypt the encrypted message. As only trusted systems, components, and devices included in and associated with the vehicle 100 possess the cryptographic keys needed to properly decrypt and/or verify the message, secure communication between devices may be facilitated, and untrusted systems may be prevented from successfully issuing control instructions to the vehicle 100 or its constituent systems.

Privacy Management

Consistent with embodiments disclosed herein, PII and/or data collected by vehicle sensors and transmitted to services may be managed consistently with an articulated and/or agreed-upon user privacy policy. For illustration, PII and/or data collected by vehicle sensors and or generated by services may include, without limitation, information related to a vehicle's usage, vehicle occupant preferences, driving habits of a driver of a vehicle, usage information regarding content, applications, and usage history of one or more vehicle systems (e.g., an IVI's purchasing history, browsing history, content rendering history), data generated by a device associated with the user (e.g., a smartphone), usage information generated by a trusted third party (e.g., a telematics service provider), and/or any other type of personal information relating to a vehicle owner, occupant, or user. In certain embodiments, PII may be volunteered by a user. In further embodiments, PII may be collected and/or generated by systems, components, and devices included in and/or associated with a vehicle.

In some embodiments, information collected and/or generated by systems, components, and devices included in and/or associated with a vehicle may not independently be considered PII. However, when such information is associated with other information (e.g., data collected via Internet-based sources), PII may be derived from the associations.

Privacy policies may identify and articulate which entities may access PII and how and whether PII may be used. In some embodiments, privacy policies may specify how data will be used and by what principals it may be used so that PII is not compromised. This may include identifying policies associated with initial and foreseeable data recipients sharing data with other entities or principals. In certain embodiments, users may be involved in articulating and/or defining policies. Users may use devices (e.g., a mobile device or computer system) to access policy management services (e.g., as provided by a trust and policy management service provider system) and to articulate and/or define policies.

Policy enforcement may be performed in a variety of ways. For example, policy enforcement can take place via negotiation of privacy policies with service providers who initially collect user information. Alternatively or additionally, policy enforcement can use data anonymization techniques that use private agents acting on behalf of a user (e.g., a personal agent). An example of such a personal agent is described in commonly assigned U.S. patent application Ser. No. 12/785,406, filed May 21, 2010, and published as Publ. No. 2010/0293049 A1 (“the '406 application”), which is hereby incorporated by reference in its entirety. For example, systems and methods disclosed herein may provide a means for anonymizing certain PII for services that do not require PII or a minimal level of detail in required PII.

In certain embodiments, policy-managed privacy protection may be used when vehicles are “temporarily” personalized in the context of car sharing or renting. For example, when renting a vehicle, a user may wirelessly pair a mobile device with an IVI and/or a telematics system included in the rental vehicle. Policy management techniques disclosed herein may be used to manage and/or prevent certain PII relating to a rental user from being accessed by other parties (e.g., a subsequent user renting a vehicle).

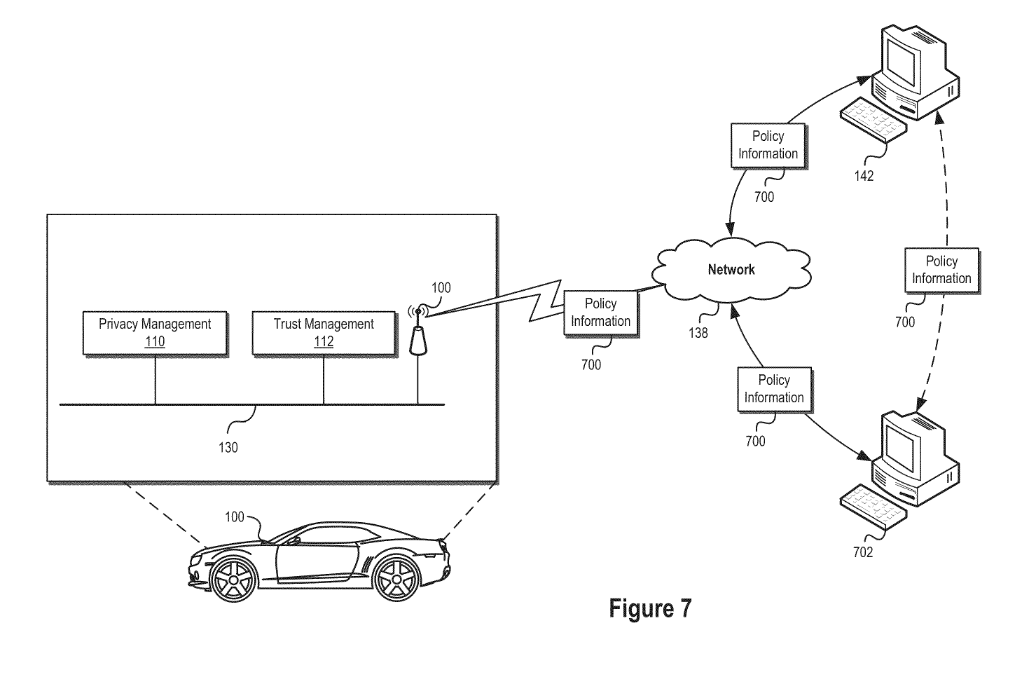

FIG. 7 illustrates an exemplary architecture for generating, transmitting, and managing policy information 700 articulating privacy management policies associated with a connected vehicle 100 consistent with embodiments of the present disclosure. In certain embodiments, policy information 700 may be generated by a user computer system 702 or other device associated with a user (e.g., a mobile device such as a smartphone or the like). Alternatively or additionally, policy information 700 may be generated by a trust and policy management system 142.

Policy information 700 may be distributed to the vehicle 100 via a communication network 138. In certain embodiments, policy information 700 may be distributed to a vehicle 100 directly by a user computer system 702. In further embodiments, policy information 700 generated by a user computer system 702 may be transmitted to a trust and policy management system 142, which may in turn distribute the policy information 700 to the vehicle.

The privacy management system 110 may be configured to implement privacy management functions, including functions relating to protecting PII associated with the vehicle 100 and/or its occupants and implementing privacy management policies expressed in policy information 700. In certain embodiments, the privacy management system 110 may be configured to distribute policy information 700 to one or more other systems, components, and devices included in and/or associated with the vehicle 100. Such distributed policy information 700 may be used by the respective systems, components, and devices to implement privacy management policies expressed in the policy information 700. For example, in certain embodiments, policy information 700 may be distributed to an ECU that has access to PII such as a telematics system. The privacy management components executing on the telematics system may use the policy information 700 to enforce privacy management policies on the dissemination and/or use of PII by the telematics system. In some embodiments, privacy management system 110, trust management system 112, one or more ECUs, and/or other vehicle systems or components may include a DRM engine such as that described in the '693 application to enforce controls that embody the privacy and/or other policies associated with data and/or communications generated or received by the vehicle.

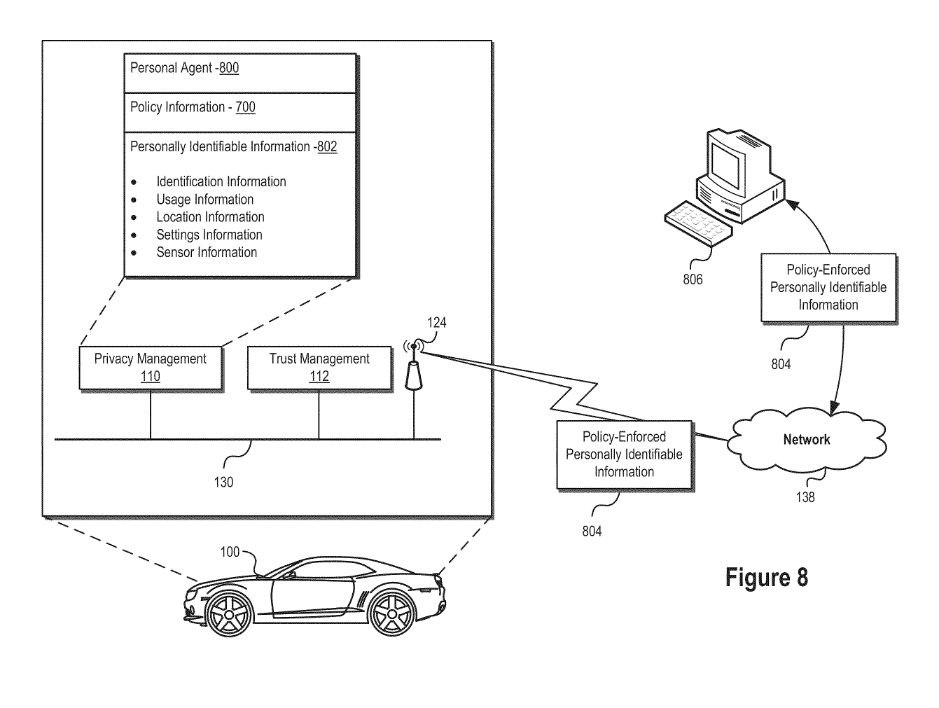

FIG. 8 illustrates an example of policy enforcement consistent with some embodiments of the present disclosure. As illustrated, a privacy management system 110 and/or other ECU included in a vehicle 100 may store policy information 700 (e.g., in the form of control programs such as those described in the '693 application). In certain embodiments, the policy information 700 may be generated by a system or device associated with a user and/or by a trust and privacy management system (not shown). The policy information 700 may, among other things, identify and articulate what entities may access PII 802 derived and/or generated by systems, components, and devices included in the vehicle 100 and how such PII 802 may be used. In certain embodiments, the policy information 700 may articulate what kinds of PII 802 may be distributed to external services and systems 806. PII 802 may include a variety of personal information including, without limitation, personal identification information, usage information, location information, vehicle settings information, information generated by vehicle sensors, and/or any other types of personal information.

Policy enforcement may be performed in a variety of ways, including using a personal agent 800 executed on the privacy management system 110 and/or any other suitable system, component, or device included in and/or associated with the vehicle 100. In certain embodiments, the personal agent 800 may be configured to store and manage PII 802 according to policy information 700. For example, the personal agent 800 may be configured to manage the use of PII 802 within the vehicle 100 and/or its constituent systems, components, and devices. In further embodiments, the personal agent 800 may be configured to manage the distribution of PII from systems, components, and devices included in and associated with the vehicle 100. In other embodiments, a DRM system such as that described in the '693 application and/or the '900 patent is used to manage PII in accordance with policies.

In certain embodiments, policy information 700 may articulate certain restrictions on the distribution of PII 802 from the vehicle 100. For example, the policy information 700 may articulate that settings information may be distributed to third party services 806, but that location information and usage information may not. Accordingly, the personal agent 800 (and/or any other suitable policy management system, including, for example, a DRM system such as that described in the '693 application or the '900 patent) may generate policy-enforced PII 804 suitable for distribution to systems external to the vehicle 100 as dictated by the privacy management policies articulated in the policy information 700.

Connected Vehicle Ecosystem Security

Implementing and deploying the systems and methods disclosed herein in a manner that is secure and that enforces articulated trust and privacy policies will typically involve analysis of the elements involved. In certain embodiments, this may include designing the trust and privacy management techniques with an understanding of ecosystem elements and functions, including, without limitation, processors, sensors, controllers, services, and information such as the processing power of systems, the ability of systems to store and protect secret information, whether elements are uniquely identifiable, support for software and/or firmware upgradability and renewal in the face of systems being compromised, as well as any other element or function. Communication networks among various system elements may also be analyzed to determine channel bandwidths, access to channel inputs and outputs, and means for protecting the integrity and confidentiality of information traversing the channels.

Application of the systems and methods disclosed herein may be approached from an ecosystem perspective. For example, two elements may interact in a secure fashion and yet still compromise one another if such interaction is not understood in a vehicle-wide connected ecosystem context. Accordingly, beyond authentication and confidentiality services, authorization services may also be considered. For example, systems and methods disclosed herein may be used to ensure that two ECUs in a connected vehicle that have no reason to communicate cannot interact through some background channel, such as a debugging interface. Similarly, if a service acquires PII relating to a user, systems and methods disclosed herein may ensure that use of the PII beyond the intended collecting service is extended only to those who are authorized consistent with articulated policies.

Establishing a Trust and Privacy Management Architecture

In certain embodiments, systems and methods disclosed herein may be implemented by a security architect entity operating within a manufacturing process of a connected vehicle. In some embodiments, the security architect entity may be associated with a trust and privacy management service provider. The entity may oversee the application and implementation of the trust and privacy management methodologies disclosed herein. In certain embodiments, aspects of the systems and methods disclosed herein may be implemented based on a security risk/benefit analysis performed by a security architect entity. In further embodiments, a security architect entity associated with a trust and privacy management service provider may plan and/or implement threat assessment capabilities, penetration testing capabilities, vulnerability monitoring capabilities, and/or breach management capabilities into the process of application of the systems and methods disclosed herein to a connected vehicle ecosystem. Based on such activities, systems and methods disclosed herein may provide a means for breach detection within the connected vehicle ecosystem and methodologies for renewing firmware and/or software functions of entities in the ecosystem when such breaches occur.

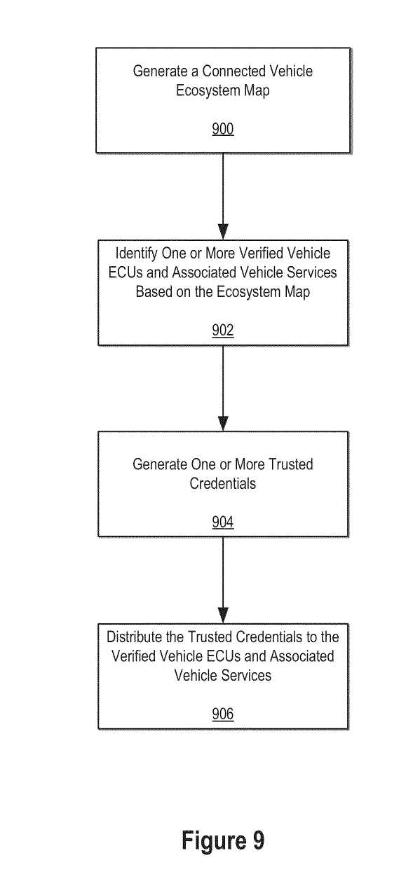

FIG. 9 illustrates a flow chart of an exemplary method of generating a trusted credential consistent with embodiments of the present disclosure. The method may begin by generating a connected vehicle ecosystem map 900. The vehicle ecosystem map may include various representations regarding relationships between entities included in a connected vehicle ecosystem. For example, relationships amongst various vehicle ECUs and/or associated vehicle services may be indicated by the connected vehicle ecosystem map. Based at least in part on the ecosystem map, a determination may be made as to which components are trusted to interact with other components and under what terms. In this manner, trust relationships between ecosystem participants may be identified and, consistent with systems and methods disclosed herein, ways in which these trusted relationships could be enforced may be determined.

In certain embodiments, based at least in part on the ecosystem map, trust verification of various entities may be performed. In certain embodiments, such trust verification may include determining that a system, component, or device included in or associated with a vehicle, or software or hardware components included therein, meets certain security requirements. Through this verification process, one or more verified vehicle ECUs and associated services may be identified 902.

One or more trusted credentials or other indicia of trust may be generated 904. In certain embodiments, the trusted credentials may be generated by a trusted authority operating a root of trust (e.g., a centralized trust and privacy management systems). The trusted credentials may then be distributed to verified vehicle ECUs and associated services and used to implement the trust management methodologies disclosed herein 906.

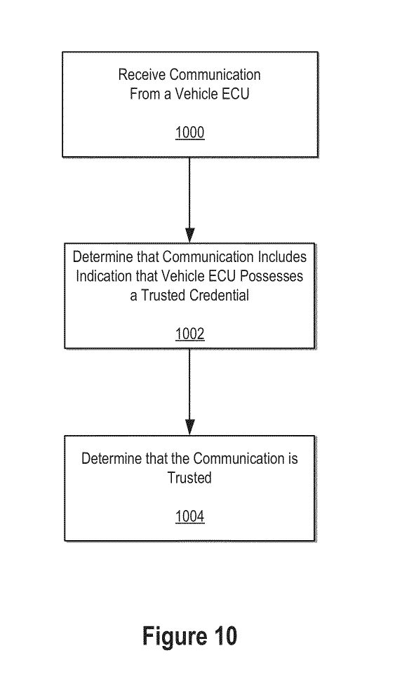

FIG. 10 illustrates a flow chart of an exemplary method of communicating between systems associated with a vehicle consistent with embodiments of the present disclosure. Particularly, the method may be used by a vehicle ECU or a service receiving a communication from a trusted vehicle ECU or service. A communication from an ECU may be received 1000. The communication may be analyzed to determine if the originating ECU is trusted (e.g., whether the communication is a trusted communication). For example, in certain embodiments, the communication may include information indicating that the originating ECU possesses a trusted credential. Determining whether the originating ECU is trusted may involve analyzing the communication to determine that the communication includes an indication (e.g., a digital signature or the like) that the originating ECU possesses a trusted credential 1002. Based on this determination, it may be determined that the communication and the originating ECU are trusted 1004.

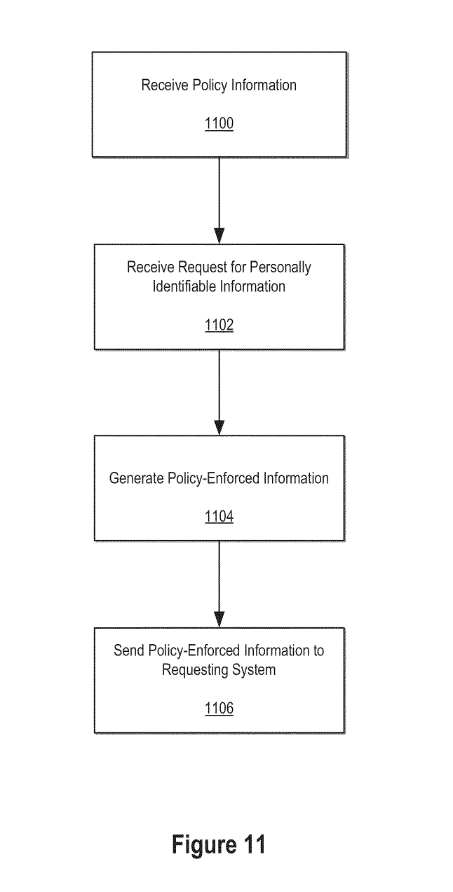

FIG. 11 illustrates a flow chart of an exemplary method of enforcing a policy consistent with embodiments of the present disclosure. In certain embodiments, the illustrated method may be performed by an ECU included in a vehicle that may generate and/or store PII. The ECU may receive policy information 1100. In certain embodiments, the policy information may be generated by a system or device associated with a user and/or by a trust and privacy management system. The policy information may, among other things, identify and articulate what entities may access certain PII, and how such PII may be used. In further embodiments, the policy information may articulate what kinds of PII may be distributed to external services and systems.

The ECU may receive a request to access certain PII 1102. For example, a service provider system may request that the ECU send certain PII generated and/or stored by the ECU. The ECU may enforce the privacy management policies articulated in the policy information on the PII. For example, the policy information may specify that information relating to a user's location should not be sent from the ECU. Based on the privacy management policies articulated in the policy information, policy-enforced information may be generated 1104. In certain embodiments, the policy-enforced information may include redacted and/or otherwise anonymized versions of the PII generated and/or stored by the ECU. Once generated, the policy-enforced information may be sent to the requesting system 1106, and/or a message may be sent to the requesting system indicating that the requested information could not be provided.

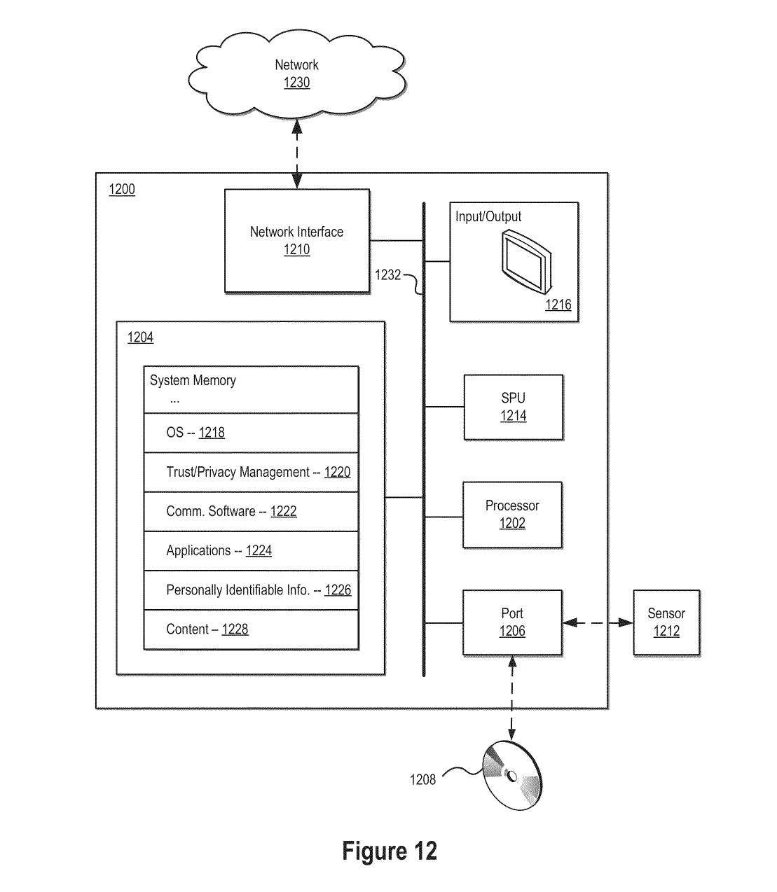

FIG. 12 illustrates an exemplary system 1200 that may be used to implement embodiments of the systems and methods disclosed herein. The exemplary system 1200 may comprise an ECU included in a vehicle such as a trust and/or privacy management system, a telematics system, or an IVI system, a general purpose computing device such as a personal computer or a network server (e.g., associated with a user or a service), or a specialized computing device such as a cellular telephone (e.g., a smartphone), a personal digital assistant, or an embedded device (e.g., a sensor), or the like. As illustrated in FIG. 12, the system 1200 may include a processing unit 1202; system memory 1204, which may include high speed random access memory (“RAM”), non-volatile memory (“ROM”), and/or one or more bulk non-volatile computer-readable storage mediums (e.g., a hard disk, flash memory, etc.) for storing programs and other data for use and execution by the processing unit 1202; one or more ports 1206 for interfacing with an associated sensor 1212 and/or with removable memory 1208 that may include one or more diskettes, optical storage mediums, memory cards, flash memory, thumb drives, USB dongles, compact discs, DVDs, and/or other computer-readable storage mediums; a network interface 1210 for communicating with other systems via one or more network connections 1230 and the like using one or more communication technologies; a user interface 1216 that may include a display and/or one or more input/output devices such as, for example, a touchscreen, a keyboard, a mouse, a track pad, and the like; and one or more busses 1232 for communicatively coupling the elements of the system 1200.

In some embodiments, the system 1200 may, alternatively or in addition, include a secure processing unit (“SPU”) 1214 that is protected from tampering by a user of system 1200 or other entities by utilizing secure physical and/or virtual security techniques. An SPU 1214 can help enhance the security of sensitive operations such as trusted credential and/or key management, privacy and policy management, and other aspects of the systems and methods disclosed herein. In certain embodiments, the SPU 1214 may operate in a logically secure processing domain and be configured to protect and operate on secret information, as described herein. In some embodiments, the SPU 1214 may include internal memory storing keys, certificates, unique identifiers, and/or executable instructions or programs configured to enable the SPU 1214 to perform secure operations, as described herein. In some embodiments an SPU such as described in commonly-assigned U.S. Pat. No. 7,430,585 and/or the '900 patent can be used.

The operation of the system 1200 may generally be controlled by a processing unit 1202 and/or a SPU 1214 operating by executing software instructions and programs stored in the system memory 1204 (and/or other computer-readable media, such as removable memory 1208). The system memory 1204 may store a variety of executable programs or modules for controlling the operation of the system 1200. For example, the system memory 1204 may include an operating system (“OS”) 1218 that may manage and coordinate, at least in part, system hardware resources and provide for common services for execution of various applications, and a trust and privacy management system 1220 for implementing trust and privacy management functionality. The system memory 1204 may further include, without limitation, communication software 1222 configured to enable in part communication within and by the system 1200, applications 1224 (e.g., media applications), PII 1226, and/or content 1228.

The systems and methods disclosed herein are not inherently related to any particular computer, electronic control unit, or other apparatus and may be implemented by any suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network. Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a disk drive, compact disk, digital-video disk, a magnetic tape, a Bernoulli drive, a magnetic disk, flash memory, integrated circuits, or any other non-transitory digital storage and/or processing apparatus or memory device.

Although the foregoing has been described in some detail for purposes of clarity, it will be apparent that certain changes and modifications may be made without departing from the principles thereof. It should be noted that there are many alternative ways of implementing both the systems and methods described herein. Accordingly, the present embodiments are to be considered as illustrative and not restrictive, and the invention is not to be limited to the details given herein, but may be modified within the scope and equivalents of the appended claims.

What is claimed is:

1. A method for creating a trusted architecture in a connected vehicle, the method comprising:
generating a connected vehicle ecosystem map including information relating to a plurality of electronic control units and network connections included in the connected vehicle;
identifying a plurality of trusted relationships involving one or more electronic control units of the plurality electronic control units based on the connected vehicle ecosystem map;
verifying that the one or more electronic control units meet one or more trust requirements;
generating one or more trusted credentials; and
issuing the one or more trusted credentials to the one or more electronic control units.

2. The method of claim 1, wherein the one or more trust requirements comprise one or more hardware requirements.

3. The method of claim 1, wherein the one or more trust requirements comprise one or more software requirements.

4. The method of claim 1, wherein the one or more trusted credentials comprise one or more trusted digital certificates.

5. The method of claim 1, wherein the one or more trusted credentials comprise one or more cryptographic keys.

6. The method of claim 1, wherein the one or more trusted credentials are configured to facilitated trusted communication between the one or more electronic control units.

7. The method of claim 1, wherein an electronic control unit of the one or more electronic control units comprises a telematics system.

8. The method of claim 1, wherein an electronic control unit of the one or more electronic control units comprises an infotainment system.

9. The method of claim 1, wherein an electronic control unit of the one or more electronic control units comprises a system facilitating communication within the vehicle.

10. The method of claim 1, wherein an electronic control unit of the one or more electronic control units comprises an engine control module system.
